(19) United States
(12) Patent Application Publication
(10) Pub. No.: US 2017/0310189 A1
(43) Pub. Date: Oct. 26, 2017

(54) Stator Cooling For Electric Machines

(71) Applicant: Ford Global Technologies, LLC, Dearborn, MI (US)

(72) Inventors: Prasad Dev Hanumalagutti, Dearborn, MI (US); Michael W. Degner, Novi, MI (US); Franco Leonardi, Dearborn Heights, MI (US)

(21) Appl. No.: 15/137,182

(22) Filed: Apr. 25, 2016

(51) Int. Cl. H02K 5/20; B60K 6/365; B60K 6/383; B60K 6/26; H02K 3/24; H02K 9/19; B60K 6/28; B60K 6/44; B60K 6/38

(52) U.S. Cl. CPC H02K 5/20; B60K 6/28; B60K 6/365; B60K 6/383; B60K 6/44; B60K 6/26; H02K 3/24; H02K 9/19; B60K 2006/381; B60Y 2200/92; B60Y 2400/604; B60Y 2400/61; Y10S 903/906; Y10S 903/907; Y10S 903/91; Y10S 903/93; Y10S 903/913

(57) ABSTRACT

A vehicle electric machine may include a rotor. The rotor may cooperate with a stator including a core having an end face, and end windings extending from the end face. A cooling tunnel may encase the end windings, sealing against the end face at opposing sides of the end windings, and defining an inlet configured to receive coolant. The cooling tunnel may be arranged to contain the coolant during passage over the end windings and direct the coolant toward an outlet.

### TECHNICAL FIELD

The present disclosure relates to cooling of stator windings in electric machines.

### BACKGROUND

Many vehicles rely on electric machines as a source of mechanical energy. Stator windings receive electric current to generate magnetic fields that cooperate with opposing magnetic fields of the rotor. Resistive heating of the stator windings due to the electric current may impose limits on the mechanical energy created by the electric machine.

### SUMMARY

A vehicle electric machine may include a rotor. The rotor may cooperate with a stator including a core having an end face, and end windings extending from the end face. A cooling tunnel may encase the end windings, sealing against the end face at opposing sides of the end windings, and defining an inlet configured to receive coolant. The cooling tunnel may be arranged to contain the coolant during passage over the end windings and direct the coolant toward an outlet.

The cooling tunnel may define the outlet. The outlet may be at an end of the cooling tunnel opposite the inlet. The cooling tunnel may extend completely around a perimeter of the end windings. The cooling tunnel may have an arcuate cross-section. The cooling tunnel may have a rectangular cross-section.

### BRIEF DESCRIPTION OF THE DRAWINGS

FIG. 1 is a schematic diagram of an example hybrid vehicle.

FIG. 2 is side view, in cross section, of a portion of an example electric machine.

FIG. 3 is a perspective view of a stator of an electric machine.

FIG. 4 is a top view of a lamination of the stator shown in FIG. 3.

FIG. 5 is a perspective view of an electric machine.

FIG. 6 is a perspective view of the cover of the electric machine shown in FIG. 5.

FIG. 7 is a cross-sectional view of the electric machine along cut line 7-7.

FIG. 8 is a perspective view of the electric machine having a cooling device according to another embodiment.

FIG. 9 is a perspective view of the cover shown in FIG. 8.

FIG. 10 is a cross-sectional view of the electric machine along cut line 10-10.

FIG. 11 is a perspective view of the electric machine having a cooling device according to another embodiment.

FIG. 12 is a perspective view of the cover shown in FIG. 11.

FIG. 13 is a side view, in cross section, of a portion of a transmission.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Electric and hybrid vehicles include permanent magnet traction motors to propel the vehicle. Permanent magnets are typically embedded around the rotor of an electric machine rotor. Opposing magnetic fields induced by the stator are used to rotate the rotor relative to the stator. The stator has a core formed of electric steel or material having a high relative magnetic permeability. A plurality of slots is distributed along an inner diameter of the stator sized to receive windings capable of carrying electric current. The windings may be configured to support three-phases to improve the magnetic field produced. Alternating three-phase current may be fed through the stator windings to induce the magnetic fields. Current may cause resistive heating of the stator windings. The stator windings may heat the core and surrounding area. Because of thermal limits, resistive heating may unnecessarily limit the mechanical output or cause degradation of the machine. Cooling systems may be used to reduce the resistive heating and increase longevity of the machine and mechanical energy output.

A cooling system may include circulating coolant in or around a stator core and windings to remove heat. A coolant loop may be a portion of a vehicle coolant system or an independent system. The coolant loop may include a radiator and coolant pump. In some instances, the coolant loop may be pressurized.

Coolant may be pumped or otherwise drawn to a cooling tunnel attached to an outer or end face of the stator. The coolant may flow through or around the stator core. The tunnel may also encase the windings, providing cooling to the end turns. The end turns may extend from the stator core, allowing entry and exit from individual stator slots while maintaining continuity. The coolant tunnel may seal against the end face of the stator on each side of the end winding. The coolant tunnel may have outlets and inlets to allow ingress and egress of coolant to other electric machine components.

The coolant tunnel may have numerous shapes and configurations. For instance, the tunnel may have a generally square or round shaped cross-section when looking at the electric machine from the side. When looking along the axis of the electric machine the coolant tunnel may have an annular shape encasing all of the end windings on that side of the stator core. The coolant tunnel may be a unitary piece or a grouping of pieces arranged to adequately cool the end windings. The coolant tunnel may encase all of the end windings. In another embodiment, the coolant tunnel may have two distinct sections in opposed quadrants of the end face. In yet another embodiment, the coolant tunnel may only occupy a portion of a right-hand half or left-hand half of the end face. The tunnel may also encase opposed sectors of the end face located between 30° and 150° and 210° and 330°. In a gravity fed embodiment, the tunnel may be oriented about the end face such that gravity draws coolant over and through the end windings from the inlet to the outlet.

A portion of the coolant tunnel may be sealed to the stator core, while another portion of the coolant tunnel has an open trough section. For example, the coolant tunnel may be one unitary piece having a tunnel portion and trough portion. The tunnel portion may be arranged so that a gravity fed inlet draws coolant through the tunnel portion and the trough portion receives coolant from the tunnel portion to guide the coolant to an outlet. The open trough portion may increase cooling of the end windings and coolant through convection cooling.

The coolant tunnel may be disposed on each side of the stator to provide coolant to the entire stator core and windings. The pair of coolant tunnels may be arranged to be fed from a common inlet or coolant loop. The coolant tunnels may be identical and opposite or employ one of the embodiments above to address asymmetry among ends of the electric machine. Meaning, a configuration with two separate tunnels on each face may be oriented to cover half of the end turn but collectively encasing all of the windings.

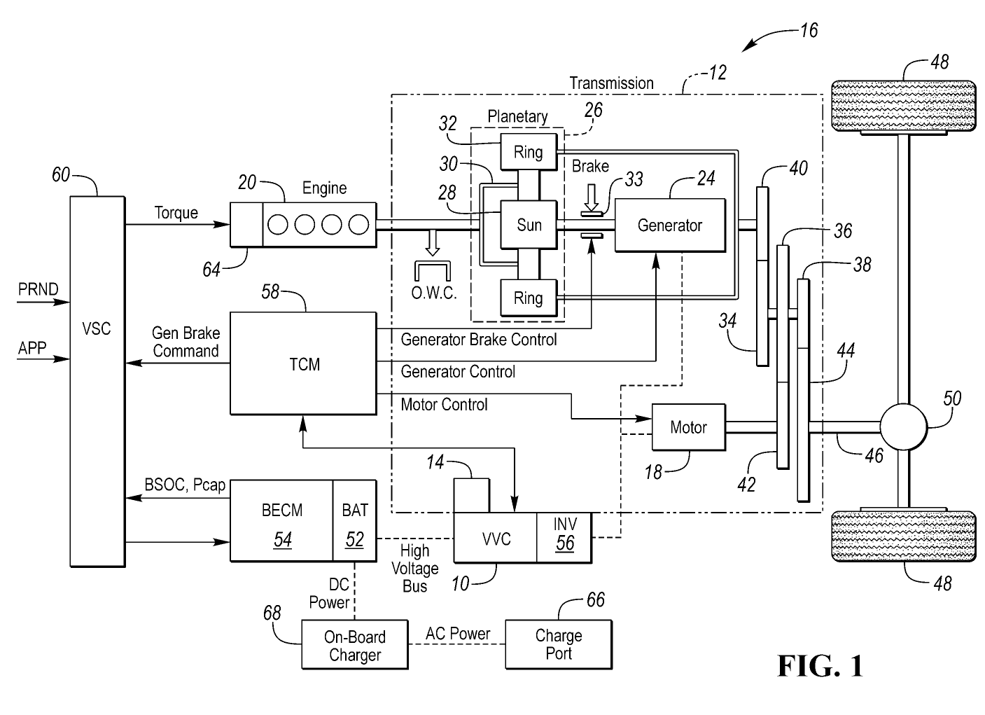

An example plugin-hybrid-electric vehicle (PHEV) is depicted in FIG. 1 and referred to generally as a vehicle 16. The vehicle 16 includes a transmission 12 and is propelled by at least one electric machine 18 with selective assistance from an internal combustion engine 20. The electric machine 18 may be an alternating current (AC) electric motor depicted as “motor” 18 in FIG. 1. The electric machine 18 receives electrical power and provides torque for vehicle propulsion. The electric machine 18 also functions as a generator for converting mechanical power into electrical power through regenerative braking.

The transmission 12 may be a power-split configuration. The transmission 12 includes the first electric machine 18 and a second electric machine 24. The second electric machine 24 may be an AC electric motor depicted as “generator” 24 in FIG. 1. Like the first electric machine 18, the second electric machine 24 receives electrical power and provides output torque. The second electric machine 24 also functions as a generator for converting mechanical power into electrical power and optimizing power flow through the transmission 12. In other embodiments, the transmission does not have a power-split configuration.

The transmission 12 may include a planetary gear unit 26, which includes a sun gear 28, a planet carrier 30, and a ring gear 32. The sun gear 28 is connected to an output shaft of the second electric machine 24 for receiving generator torque. The planet carrier 30 is connected to an output shaft of the engine 20 for receiving engine torque. The planetary gear unit 26 combines the generator torque and the engine torque and provides a combined output torque about the ring gear 32. The planetary gear unit 26 functions as a continuously variable transmission, without any fixed or “step” ratios.

The transmission 12 may also include a one-way clutch (O.W.C.) and a generator brake 33. The O.W.C. is coupled to the output shaft of the engine 20 to only allow the output shaft to rotate in one direction. The O.W.C. prevents the transmission 12 from back-driving the engine 20. The generator brake 33 is coupled to the output shaft of the second electric machine 24. The generator brake 33 may be activated to “brake” or prevent rotation of the output shaft of the second electric machine 24 and of the sun gear 28. Alternatively, the O.W.C. and the generator brake 33 may be eliminated and replaced by control strategies for the engine 20 and the second electric machine 24.

The transmission 12 may further include a countershaft having intermediate gears including a first gear 34, a second gear 36 and a third gear 38. A planetary output gear 40 is connected to the ring gear 32. The planetary output gear 40 meshes with the first gear 34 for transferring torque between the planetary gear unit 26 and the countershaft. An output gear 42 is connected to an output shaft of the first electric machine 18. The output gear 42 meshes with the second gear 36 for transferring torque between the first electric machine 18 and the countershaft. A transmission output gear 44 is connected to a driveshaft 46. The driveshaft 46 is coupled to a pair of driven wheels 48 through a differential 50. The transmission output gear 44 meshes with the third gear 38 for transferring torque between the transmission 12 and the driven wheels 48.

The vehicle 16 includes an energy storage device, such as a traction battery 52 for storing electrical energy. The battery 52 is a high-voltage battery that is capable of outputting electrical power to operate the first electric machine 18 and the second electric machine 24. The battery 52 also receives electrical power from the first electric machine 18 and the second electric machine 24 when they are operating as generators. The battery 52 is a battery pack made up of several battery modules (not shown), where each battery module contains a plurality of battery cells (not shown). Other embodiments of the vehicle 16 contemplate different types of energy storage devices, such as capacitors and fuel cells (not shown) that supplement or replace the battery 52. A high-voltage bus electrically connects the battery 52 to the first electric machine 18 and to the second electric machine 24.

The vehicle includes a battery energy control module (BECM) 54 for controlling the battery 52. The BECM 54 receives input that is indicative of vehicle conditions and battery conditions, such as battery temperature, voltage and current. The BECM 54 calculates and estimates battery parameters, such as battery state of charge and the battery power capability. The BECM 54 provides output (BSOC, P_{cap}) that is indicative of a battery state of charge (BSOC) and a battery power capability (P_{cap}) to other vehicle systems and controllers.

The vehicle 16 includes a DC-DC converter or variable voltage converter (VVC) 10 and an inverter 56. The VVC 10 and the inverter 56 are electrically connected between the traction battery 52 and the first electric machine 18, and between the battery 52 and the second electric machine 24. The VVC 10 “boosts” or increases the voltage potential of the electrical power provided by the battery 52. The VVC 10 also “bucks” or decreases the voltage potential of the electrical power provided to the battery 52, according to one or more embodiments. The inverter 56 inverts the DC power supplied by the main battery 52 (through the VVC 10) to AC power for operating the electric machines 18, 24. The inverter 56 also rectifies AC power provided by the electric machines 18, 24, to DC for charging the traction battery 52. Other embodiments of the transmission 12 include multiple inverters (not shown), such as one invertor associated with each electric machine 18, 24. The VVC 10 includes an inductor assembly 14.

The transmission 12 includes a transmission control module (TCM) 58 for controlling the electric machines 18, 24, the VVC 10 and the inverter 56. The TCM 58 is configured to monitor, among other things, the position, speed, and power consumption of the electric machines 18, 24. The TCM 58 also monitors electrical parameters (e.g., voltage and current) at various locations within the VVC 10 and the inverter 56. The TCM 58 provides output signals corresponding to this information to other vehicle systems.

The vehicle 16 includes a vehicle system controller (VSC) 60 that communicates with other vehicle systems and controllers for coordinating their function. Although it is shown as a single controller, the VSC 60 may include multiple controllers that may be used to control multiple vehicle systems according to an overall vehicle control logic, or software.

The vehicle controllers, including the VSC 60 and the TCM 58 generally includes any number of microprocessors, ASICs, ICs, memory (e.g., FLASH, ROM, RAM, EPROM and/or EEPROM) and software code to co-act with one another to perform a series of operations. The controllers also include predetermined data, or “look up tables” that are based on calculations and test data and stored within the memory. The VSC 60 communicates with other vehicle systems and controllers (e.g., the BECM 54 and the TCM 58) over one or more wired or wireless vehicle connections using common bus protocols (e.g., CAN and LIN). The VSC 60 receives input (PRND) that represents a current position of the transmission 12 (e.g., park, reverse, neutral or drive). The VSC 60 also receives input (APP) that represents an accelerator pedal position. The VSC 60 provides output that represents a desired wheel torque, desired engine speed, and generator brake command to the TCM 58; and contactor control to the BECM 54.

The vehicle 16 includes an engine control module (ECM) 64 for controlling the engine 20. The VSC 60 provides output (desired engine torque) to the ECM 64 that is based on a number of input signals including APP, and corresponds to a driver's request for vehicle propulsion.

If the vehicle 16 is a PHEV, the battery 52 may periodically receive AC energy from an external power supply or grid, via a charge port 66. The vehicle 16 also includes an on-board charger 68, which receives the AC energy from the charge port 66. The charger 68 is an AC/DC converter which converts the received AC energy into DC energy suitable for charging the battery 52. In turn, the charger 68 supplies the DC energy to the battery 52 during recharging. Although illustrated and described in the context of a PHEV 16, it is understood that the electric machines 18, 24 may be implemented on other types of electric vehicles, such as a hybrid-electric vehicle or a fully electric vehicle.

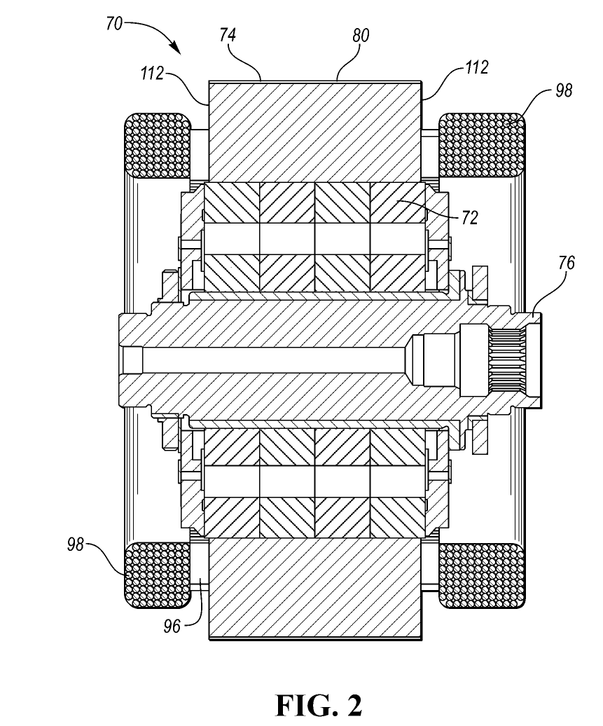

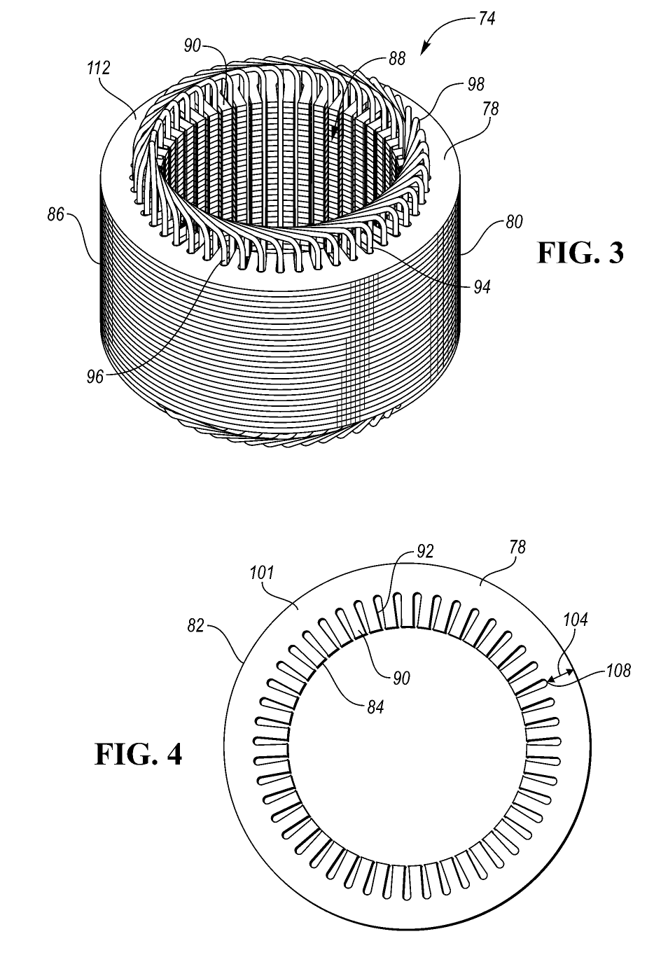

Referring to FIGS. 2, 3, and 4, an example electric machine 70 includes a stator 74 having a plurality of laminations 78. Each of the laminations 78 includes a front side 101 and a back side. When stacked, the front and back sides are disposed against adjacent front and back sides to form a stator core 80. Each of the laminations 78 may be doughnut shaped and may define a hollow center. Each lamination 78 also includes an outer diameter (or outer wall) 82 and an inner diameter (or inner wall) 84. The outer diameters 82 cooperate to define an outer surface 86 of the stator core 80, and the inner diameters 84 cooperate to define a cavity 88.

Each lamination 78 includes a plurality of teeth 90 extending radially inward toward the inner diameter 84. Adjacent teeth 90 cooperate to define slots 92. The teeth 90 and the slots 92 of each lamination 78 are aligned with adjacent laminations to define stator slots 94 extending through the stator core 80 between the opposing end faces 112. A plurality of windings (also known as coils, wires, or conductors) 96 are wrapped around the stator core 80 and are disposed within the stator slots 94. The windings 96 may be disposed in an insulating material (not shown). Portions of the windings 96 generally extend in an axial direction along the stator slots 94. At the end faces 112 of the stator core, the windings bend to extend circumferentially around the end faces 112 of the stator core 80 forming the end windings 98. The end faces 112 define the opposing ends of the core 80 and are formed by the first and last laminations of the stator core 80. While shown as having distributed windings, the windings could also be of the concentrated type.

A rotor 72 is disposed within the cavity 88. The rotor 72 is fixed to a shaft 76 that is operably connected to the gearbox. When current is supplied to the stator 74, a magnetic field is created causing the rotor 72 to spin within the stator 74 generating a torque that is supplied to the gearbox via one or more shafts. During operation, the electric machine 70 generates heat within the stator core 80 and the windings 96. To prevent overheating of the electric machine, a fluid circuit may be provided to remove heat generated during operation.

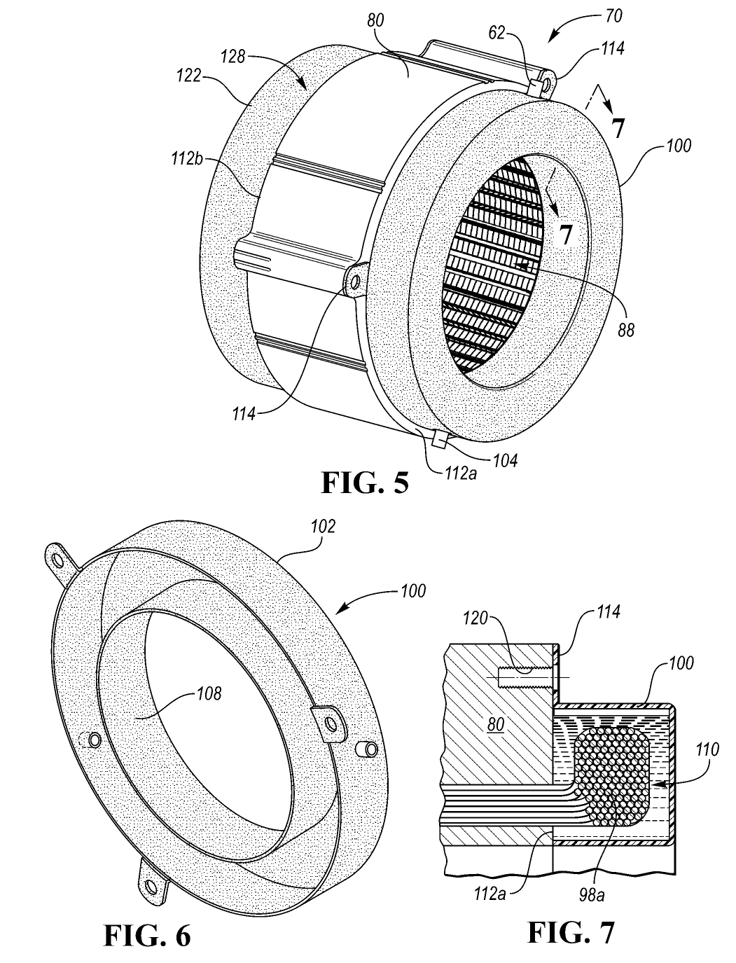

Referring to FIGS. 5, 6, and 7, the electric machine 70 may be cooled by circulating a cooling medium over the end windings 98. The cooling medium may be oil (such as transmission fluid), or any other suitable heat transfer liquid. A cooling device may be used to convey the cooling medium over the end windings 98. A cooling tunnel 100 is mounted to the stator core 80 covering the end windings 98. The cooling tunnel 100 may be sealed against the end faces 112a. The cooling tunnel 100 may include an inlet 102 to receive coolant from the cooling circuit. The inlet may be an orifice, connecting tube, or opening depending on the pressure of the received coolant. For example, a pressurized coolant system may require a fitting to connect a coolant channel to the inlet 102. A gravity fed system may only require an opening configured to catch dripping coolant. The cooling tunnel 100 may also define an outlet 104. The outlet may have different configurations, also depending on whether the coolant circuit is pressurized. For example, the coolant may be released to a coolant sump or connected to a coolant return through piping or hosing. The inlet 102 and outlet 104 may also be configured as part of the housing of the electric machine 70. The outlet 104 may be positioned relative to the inlet 102 such that gravity directs coolant received at the inlet 102 to the outlet 104, after passing over the end windings 98.

The coolant tunnel 100 includes mounting ears 114 for attaching the tunnel 100 to the end face 112a. Each of the mounting ears 114 may be bent substantially perpendicular to the wall of the tunnel and includes a hole for receiving a fastener 120 to attach the ear 114 to the stator core 80.

The electric machine 70 may include a second cooling tunnel 122 cooperating with a second end face 112b. The second cooling tunnel 122 may be similar to the first tunnel 100 and also include mounting ears for attaching the tunnel 122 to the electric machine 70. As shown in FIG. 7, the cooling tunnel has a rectangular cross-section.

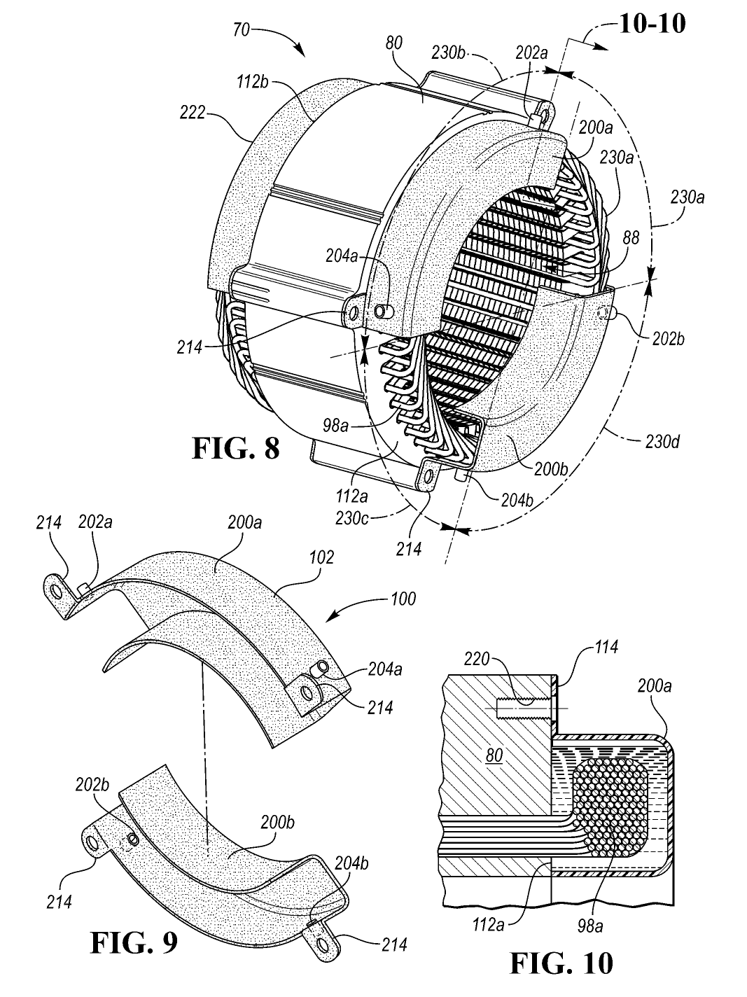

Referring now to FIGS. 8, 9, and 10, a cooling tunnel has multiple tunnel sections 200a and 200b. Each of the sections 200a, 200b is configured to cool the electric machine 70. The sections 200a, 200b may be oriented in multiple ways to adequately cool the electric machine 70. The sections 200a, 200b may have varying lengths to support adequate cooling. For example, the sections 200a, 200b may be situated in particular quadrants 230a, 230b, 230c, 230d of the end face 212a. As shown, the sections 200a, 200b encase the windings 98a in only the second quadrant 230b and fourth quadrant 230d. Each of the sections 200a, 200b includes joint or independent inlets 202a and 202b, respectively. Depending on the orientation of the sections 200a, 200b the inlets 202a, 202b may be fed from the same channel or separate channels. Each section 200a, 200b includes ears 214 to connect the section to the electric machine. The sections 200a, 200b may be oriented to occupy portions of the second and third quadrants 230b, 230 and first and fourth quadrants 230a, 230d, respectively. In this orientation the first inlet 202a is located in the first quadrant 230a, and the first outlet 204a is located in the fourth quadrant 230d. The second inlet 202b is located in the second quadrant 230b, and the second outlet 204b is located in the third quadrant 230c. This orientation may provide benefit in that the inlets 202a, 202b and outlets 204a, 204b are relatively closer together and oriented for an improved gravity fed design. As shown in FIG. 10, the cooling tunnel has an arcuate cross-section. Each of the open areas at the ends of sections 200a and 200b may be sealed using epoxy or similar substance to seal the ends of the tunnels (not shown).

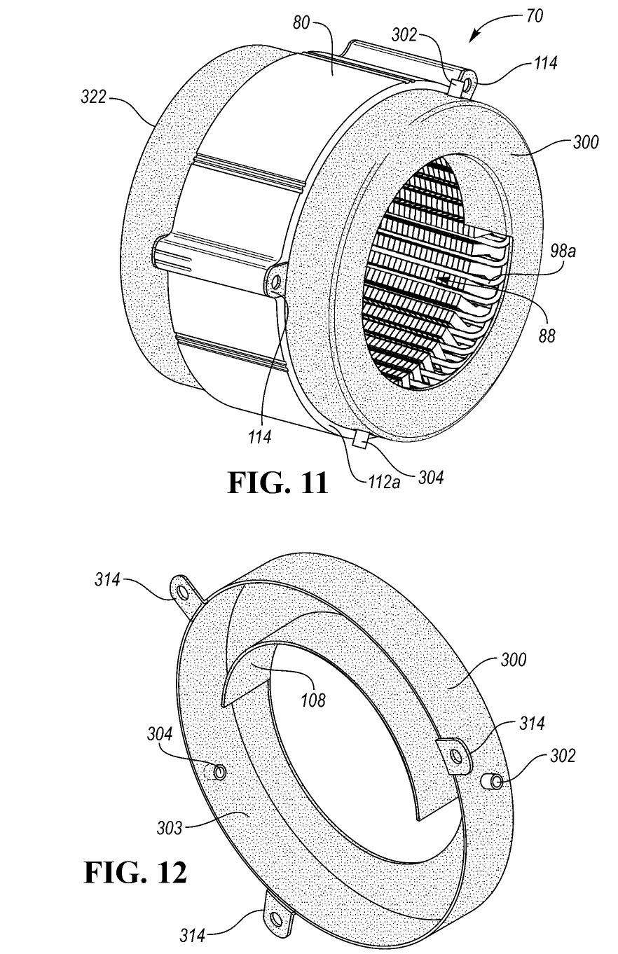

Now referring to FIGS. 11 and 12, the cooling tunnel or conduit 300 may enclose a portion of the set of end windings 98a. A trough 303 provides cooling for the other portion of the set of end windings 98a. The cooling tunnel 300 and trough 303 are a unitary piece. The cooling tunnel 300 includes an inlet 302. The trough 303 includes an outlet 304. Coolant enters the cooling tunnel through the inlet 302 and exits through the outlet 304 of the trough 303. This configuration may provide additional convention cooling of end windings otherwise unavailable with a complete cooling tunnel encasing the entire set of end windings.

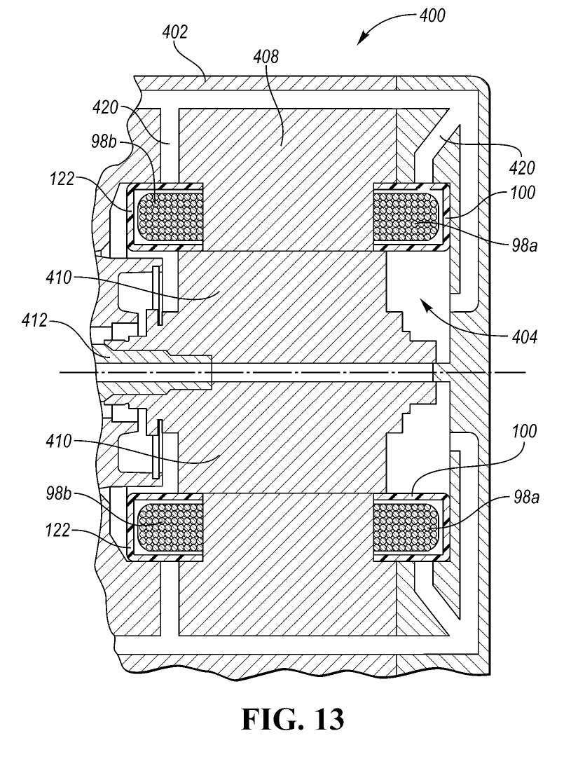

Referring to FIG. 13, a hybrid transmission 400 includes a housing 402 defining a cavity 404. An electric machine 406 (which may be the same or similar to electric machine 70) is supported within the cavity 404. The electric machine 406 includes a stator 408 that is mounted to the housing 402 such that the stator 408 is unable to rotate relative to the housing 402. The rotor 410 is disposed within the stator and is fixed (e.g., splined) to a shaft 412. The shaft 412 may connect to the gear box.

The electric machine includes a pair of tunnels 100, 122 (which may be the same or similar to tunnels 100, 200a, 300) connected to the stator 408 to form cooling channels around the end windings 98a. The first tunnel 100 is positioned in the transmission such that passageway 420 conveys oil into the channel of the tunnel 100 through the inlet. The second tunnel 122 is positioned in the transmission such that a different section of passageway 420 conveys oil into the channel of the tunnel 122 through the inlet. The oil circulates through the channels to cool the end windings 98b. The oil exits the channels through the open bottom and drains to the transmission sump via passageways (not shown) of the transmission.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle electric machine comprising:
a rotor;
a stator including a core having an end face, and end windings extending from the end face; and
a cooling tunnel encasing the end windings, sealing against the end face at opposing sides of the end windings, and defining an inlet configured to receive coolant, the cooling tunnel arranged to contain the coolant during passage over the end windings and direct the coolant toward an outlet.

2. The vehicle electric machine of claim 1, wherein the cooling tunnel defines the outlet.

3. The vehicle electric machine of claim 2, wherein the outlet is at an end of the cooling tunnel opposite the inlet.

4. The vehicle electric machine of claim 1, wherein the cooling tunnel extends completely around a perimeter of the end windings.

5. The vehicle electric machine of claim 1, wherein the cooling tunnel has an arcuate cross-section.

6. The vehicle electric machine of claim 1, wherein the cooling tunnel has a rectangular cross-section.

7. A vehicle electric machine comprising:
a rotor;
a stator including a core having an end face, and end windings extending from the end face; and
a plurality of cooling tunnels encasing the end windings, sealing against the end face at opposing sides of the end windings and each end of the tunnels, and each defining an inlet configured to receive coolant, the cooling tunnels arranged to contain the coolant during passage over the end windings and direct the coolant toward outlets.

8. The vehicle electric machine of claim 7, wherein each of the cooling tunnels defines the outlet.

9. The vehicle electric machine of claim 8, wherein each of the outlets is at an end of each of the cooling tunnels opposite the inlet.

10. The vehicle electric machine of claim 7, wherein the cooling tunnels are situated in a second and fourth quadrant of the end face covering the windings therein.

11. The vehicle electric machine of claim 7, wherein the cooling tunnels have an arcuate cross-section.

12. The vehicle electric machine of claim 7, wherein the cooling tunnels have a rectangular cross-section.

13. A vehicle electric machine comprising:
a rotor;
a stator including a core having an end face, and end windings extending from the end face; and
a cooling conduit encasing the end windings, having a cooling tunnel portion and a cooling trough portion, the cooling tunnel portion sealing against the end face at opposing sides of the end windings and the cooling trough portion sealing against the end face at one of the sides of the end windings, and defining an inlet configured to receive coolant, the cooling conduit arranged to retain the coolant during passage over the end windings and direct the coolant toward an outlet.

14. The vehicle electric machine of claim 13, wherein the inlet is defined on the cooling tunnel portion.

15. The vehicle of claim 14, wherein the outlet is defined on the cooling trough portion.

16. The vehicle of claim 13, wherein the cooling conduit extends completely around a perimeter of the windings.

17. The vehicle electric machine of claim 13, wherein the cooling conduit has an arcuate cross-section.

18. The vehicle electric machine of claim 13, wherein the cooling conduit has a rectangular cross-section.
